(19) United States
(12) Patent Application Publication
(10) Pub. No.: US 2025/0314755 A1
(43) Pub. Date: Oct. 9, 2025

(54) OBSTRUCTION DETECTION METHODS AND OBSTRUCTION DETECTION DEVICES FOR LIDARS, AND LIDARS

(71) Applicant: HESAI TECHNOLOGY CO., LTD., Shanghai (CN)

(72) Inventors: Qingguo YU, Shanghai (CN); Xin ZHAO, Shanghai (CN); Lei WANG, Shanghai (CN); Shaoqing XIANG, Shanghai (CN)

(73) Assignee: HESAI TECHNOLOGY CO., LTD., Shanghai (CN)

(21) Appl. No.: 19/243,206

(22) Filed: Jun. 19, 2025

Related U.S. Application Data
(63) Continuation of application No. PCT/CN2023/141235, filed on Dec. 22, 2023.

(30) Foreign Application Priority Data
Dec. 22, 2022 (CN) 202211665205.2

(51) Int. Cl. G01S 7/497; G01S 7/48; G01S 7/481; G01S 7/484; G01S 7/487

(52) U.S. Cl. CPC G01S 7/497; G01S 7/4802; G01S 7/4817; G01S 7/484; G01S 7/4873; G01S 2007/4975

(57) ABSTRACT

An obstruction detection method includes: determining an obstruction time window, such that a distance corresponding to the obstruction time window is within a blind zone of the LiDAR (602); and determining whether an obstruction exists based on a characteristic parameter of an echo generated by a detection light within the obstruction time window (603,604).

### CROSS-REFERENCE TO RELATED APPLICATION(S)

This application claims priority to Chinese Patent Application No. 202211665205.2, filed on Dec. 22, 2022, the content of which is incorporated herein by reference in its entirety.

### TECHNICAL FIELD

This disclosure relates to the field of LiDARs, and in particular to obstruction detection methods and obstruction detection devices for a LiDAR, and LiDARs.

### BACKGROUND

Currently, LiDARs are applied in an increasingly wide range of areas. A LiDAR can include components such as a light emitter, a light receiver, and a cover (e.g., a window). The LiDAR can be a non-contact measuring device. The cleanliness of the cover and other obstruction that blocks the light path of the LiDAR can affect the range and measurement accuracy of the LiDAR directly. The LiDAR can use a paraxial transreceiver optics system. Typically, a blind zone can exist in a close range of the LiDAR (e.g., as shown in FIG. 1). In the case of the paraxial transreceiver optics system, the field of view (“FOV”) of the light emitter and the FOV of the light receiver do not overlap in the short range close to the LiDAR. Within this distance range, an echo received by the light receiver can be typically weak. The echo can be difficult to be identified. This distance range forms the blind zone.

The LiDAR can emit detection light and receive an echo reflected by an object to detect information, such as a distance from the object, reflectivity of the object, or the like. An obstruction exists in the blind zone or the surface of the cover is dirty, the light emitting path of the detection light can be affected, affecting detection of a long-distance object by the LiDAR. Therefore, the accurate detection of the obstruction (e.g., the dirt of the cover) is conducive to the normal detection of the LiDAR.

### SUMMARY

Embodiments of this disclosure provide obstruction detection methods and obstruction detection devices for a LiDAR, and LiDARs. In this disclosure, an obstruction in the light emitting path of the LiDAR can be detected accurately and normal detection of the LiDAR can be improved or ensured.

In view of this, the embodiments of this disclosure provide the following technical solution.

In a first aspect, some embodiments of this disclosure provide a method of obstruction detection for a LiDAR. The method includes: determining an obstruction time window, wherein a distance corresponding to the obstruction time window is within a blind zone of the LiDAR; and determining whether an obstruction exists based on a characteristic parameter of an echo generated by a detection light within the obstruction time window.

Optionally, the method includes: emitting a detection light; and obtaining an echo generated by the detection light within the obstruction time window.

In a second aspect, some embodiments of this disclosure provide a method of obstruction detection for a LiDAR. The method includes: emitting a detection light; determining an obstruction time window, wherein a distance corresponding to the obstruction time window is within a blind zone of the LiDAR; obtaining an echo generated by the detection light within the obstruction time window; and determining whether an obstruction exists based on a characteristic parameter of the echo generated by the detection light within the obstruction time window.

In the first aspect and the second aspect, there are some optionally implementations.

Optionally, the characteristic parameter of the echo includes a number of echoes. The detection light is a plurality of beams of detection light formed by emission of a plurality of light emitters in the LiDAR. The number of echoes is the number of echoes that are able to be generated by the plurality of beams of detection light within the obstruction time window.

The determining whether an obstruction exists based on a characteristic parameter of the echo includes: determining that the obstruction exists when the number of echoes is greater than a determined quantity threshold.

Optionally, the method further includes: dividing a field of view of the LiDAR into a plurality of regions; and counting the number of echoes generated by the detection light within the obstruction time window in each region.

The determining whether an obstruction exists based on a characteristic parameter of the echo includes: determining whether the obstruction exists in each region in the field of view based on the counted number of the echoes generated by the detection light within the obstruction time window in the region.

Optionally, an area of the region is greater than or equal to a smaller area of a spot area of the detection light on a cover of the LiDAR and a corresponding field of view area of the detection light on the cover of the LiDAR. The area of the region refers to an area of the region projected onto the cover of the LiDAR.

Optionally, the determining whether the obstruction exists in each region in the field of view based on the counted number of the echoes in the region includes: obtaining the number of the echoes generated by the detection light within the obstruction time window in each region in turn; and determining that the obstruction exists in the region when the number of the echoes generated by the detection light within the obstruction time window in the region is greater than or equal to a first threshold.

Optionally, the determining whether the obstruction exists in each region in the field of view based on the counted number of the echoes in the region further includes: determining that the obstruction exists in a current region, when the number of echoes generated by the detection light within the obstruction time window in the current region is less than the first threshold, and when a sum of the number of echoes generated by the detection light within the obstruction time window in any adjacent region and the number of the echoes generated by the detection light within the obstruction time window in the current region is greater than or equal to a second threshold.

Optionally, the method further includes: determining a distribution of the obstruction based on the determination of whether the obstruction exists in each region.

Optionally, the determining a distribution of the obstruction includes: determining a status mark of the region depending on whether the obstruction exists in the region; determining a distribution region of the obstruction based on the status mark of each region; and/or determining a degree of occlusion of the obstruction based on the status mark of each region.

Optionally, the method further includes: dividing the field of view into a plurality of regions; and counting the number of the echoes generated by the detection light within the obstruction time window in each region for a plurality of times in sequence. The determining whether an obstruction exists based on the a characteristic parameter of the echo generated by the detection light within the obstruction time window includes: determining that the obstruction exists in the region when the number of times that the number of the echoes generated by the detection light within the obstruction time window in the region is greater than or equal to the first threshold among the plurality of times in sequence is greater than a determined threshold for the number of times.

Optionally, the method further includes: counting the number of echoes generated by the detection light outside the obstruction time window in each region; and determining a type of the obstruction based on the counted number of the echoes generated by the detection light outside the obstruction time window in each region, when it is determined that the obstruction exists in the region.

Optionally, the determining a type of the obstruction based on the counted number of the echoes generated by the detection light outside the obstruction time window in each region includes: determining that the obstruction is a first type of obstruction when the number of the echoes generated by the detection light outside the obstruction time window in the region is less than a third threshold; and otherwise, determining that the obstruction is a second type of obstruction, a degree of occlusion of the first type of obstruction is greater than a degree of occlusion of the second type of obstruction.

Optionally, the method further includes: determining the first threshold and the third threshold in advance by means of calibration.

Optionally, the method further includes: updating the third threshold in a dynamic manner based on a surrounding environment of the LiDAR.

Optionally, the updating the third threshold in a dynamic manner based on a surrounding environment of the LiDAR includes: obtaining the third threshold for a current obstruction detection based on the third threshold for a last obstruction detection and a historically counted number of the echoes generated by the detection light outside the obstruction time window.

Optionally, the characteristic parameter of the echo includes at least one of: a pulse width, a peak value, or an integral value. The determining whether an obstruction exists based on a characteristic parameter of the echo generated by the detection light within the obstruction time window includes: determining that the obstruction exists when the characteristic parameter of the echo generated by the detection light within the obstruction time window is greater than a determined identification threshold.

Optionally, determining whether an obstruction exists based on a characteristic parameter of the echo generated by the detection light within the obstruction time window includes: determining that no obstruction exists when no echo is generated by the detection light within the obstruction time window and when an echo is generated outside the obstruction time window.

Optionally, the characteristic parameter of the echo includes the number of echoes. The detection light is a single beam of detection light emitted by a light emitter in the LiDAR. The number of echoes is the number of echoes generated by the single beam of detection light within the obstruction time window. The method further includes: determining whether the obstruction is caused by weather based on the number of echoes.

Optionally, the method further includes: reporting fault information based on a result of obstruction detection.

In a third aspect, some embodiments of this disclosure also provide an obstruction detection device for a LiDAR. The obstruction detection device includes a light emitter, a light receiver and a determination module. The light emitter is configured to emit detection light. The light receiver is configured to obtain an echo generated by the detection light within an obstruction time window. The obstruction time window is determined based on a detection range where a point cloud is unable to be generated after emission of the detection light. The determination module is configured to determine whether an obstruction exists based on a characteristic parameter of the echo generated by the detection light within the obstruction time window.

In a fourth aspect, some embodiments of this disclosure also provide a LiDAR. The LiDAR includes a light emitter, a light receiver and a controller. The light emitter is configured to emit detection light. The light receiver is configured to receive an echo generated by the detection light within an obstruction time window and/or an echo generated by the detection light outside the obstruction time window. The controller stores a computer program. The controller, when executing the computer program, implements steps of the obstruction detection method for the LiDAR described above.

In a fifth aspect, some embodiments of this disclosure also provide a terminal device comprises: LiDAR described in above embodiments and a connector, configured to connect the LiDAR and the terminal device.

Optionally, the terminal device includes a car, a drone or a robot.

With the obstruction detection method and obstruction detection device for the LiDAR and the LiDAR provided in some embodiments of this disclosure, an echo generated by the emitted detection light within an obstruction time window is obtained based on the waveform of the echo when an obstruction exists in a blind zone by determining the obstruction time window such that a distance corresponding to the obstruction time window is within the blind zone of the LiDAR. Whether an obstruction exists is determined based on the characteristic parameter of the echo generated by the detection light within the obstruction time window.

Further, when the detection light includes multiple beams of detection light emitted by multiple light emitters in the LiDAR separately, by counting the number of echoes, for example, the number of echoes generated by the multiple beams of detection light within the obstruction time window. By doing so, detection of the obstruction is achieved based on the counted number of echoes.

Furthermore, the field of view can be divided into multiple regions, and the number of echoes generated within the obstruction time window can be counted region by region. It is determined whether an obstruction exists in each region based on the counted result, and further the distribution region and/or the degree of occlusion of the obstruction can be determined. By doing so, a more comprehensive and accurate detection result for the status of the obstruction can be obtained.

Furthermore, the type of obstruction can be determined by counting the number of echoes generated by the detection light outside the obstruction time window in each region, and a more fine-grained detection result can be obtained. By doing so, more appropriate approaches can be taken based on different types of obstructions.

Further, the characteristic parameter of the echo can include one or more of the pulse width, peak value, and integral value of the echo. These characteristic parameters can be statistically counted to determine whether an obstruction exists. The solution of this disclosure can be applied more flexibly. Furthermore, when the detection light is emitted by a light emitter in the LiDAR, the number of echoes can also be counted to determine whether it is an obstruction caused by the weather, so that the solution of this disclosure can realize the detection of an obstruction for various weather environments during application of the LiDAR. Moreover, it is possible to effectively distinguish whether the obstruction is caused by weather or other reasons. By doing so, the robustness of the solution of this disclosure and the accuracy of obstruction detection can be improved.

The solution of this disclosure detects an obstruction based on counted data. By doing so, the detection result can be more accurate. Moreover, the solution of this disclosure has strong scalability. For example, it can provide a variety of detection results based on detection requirements, such as whether an obstruction exists, a distribution of the obstruction, a type of the obstruction, a severity of occlusion, or the like. In addition, the solution of this disclosure can be implemented directly via software. Therefore, it is not required to change the hardware of the existing LiDAR to realize detection of an obstruction without increasing the cost.

### BRIEF DESCRIPTION OF THE DRAWINGS

To explain some embodiments of this disclosure or the technical solutions in the existing techniques more clearly, the drawings needed to be used in the description of some embodiments or the prior art are introduced below. It is apparent that the drawings in the following description are merely some embodiments of this disclosure. Other drawings can be obtained by those of ordinary skill in the art based on the provided drawings without creative efforts.

FIG. 1 shows a schematic diagram of an example blind zone of a LiDAR.

FIG. 2 shows a schematic diagram of an example relationship between a blind zone and a ranging region of a LiDAR with a 360-degree FOV.

FIG. 3 shows a schematic diagram of an example relationship between a blind zone and a ranging region of a LiDAR with a non-360-degree FOV.

FIG. 4a shows a schematic diagram of an example detection light path of a LiDAR when no obstruction exists.

FIG. 4b shows a schematic diagram of an example echo corresponding to FIG. 4a when no obstruction exists.

FIG. 5a shows a schematic diagram of an example detection light path of a LiDAR when an obstruction exists.

FIG. 5b shows a schematic diagram of an example echo corresponding to FIG. 5a when an obstruction exists.

FIG. 6 shows a flow chart of an example obstruction detection method for a LiDAR, consistent with some embodiments of this disclosure.

FIG. 7 shows another flow chart of an example obstruction detection method for a LiDAR, consistent with some embodiments of this disclosure.

FIG. 8 shows a schematic diagram of example divided regions of a detection field of view of a LiDAR with multiple light emitter groups, consistent with some embodiments of this disclosure.

FIG. 9 shows a schematic diagram of regions of an example field of view of a LiDAR divided based on a horizontal space, consistent with some embodiments of this disclosure.

FIG. 10 shows a schematic diagram of regions of an example field of view of a LiDAR divided based on horizontal and vertical spaces, consistent with some embodiments of this disclosure.

FIG. 11 shows a flow chart illustrating an example implementation of an obstruction detection method for a LiDAR, consistent with some embodiments of this disclosure.

FIG. 12 shows a flow chart illustrating another example implementation of an obstruction detection method for a LiDAR, consistent with some embodiments of this disclosure.

FIG. 13 shows a flow chart illustrating yet another example implementation of an obstruction detection method for a LiDAR, consistent with some embodiments of this disclosure.

FIG. 14 shows an example of an example status mark of a region, consistent with some embodiments of this disclosure.

FIG. 15 shows an example of another example status mark of a region, consistent with some embodiments of this disclosure.

FIG. 16 shows a schematic diagram of an example impact on detection signals in the case of different types of obstructions.

FIG. 17 shows a flow chart illustrating another example implementation of an obstruction detection method for a LiDAR, consistent with some embodiments of this disclosure.

FIG. 18 shows a schematic structural diagram of an example obstruction detection device for a LiDAR, consistent with some embodiments of this disclosure.

FIG. 19 shows a schematic structural diagram of an example LiDAR, consistent with some embodiments of this disclosure.

### DETAILED DESCRIPTION

To make the above objects, features and beneficial effects of this disclosure clearer and more understandable, some embodiments of this disclosure are described in detail below with reference to the accompanying drawings.

In the description of this disclosure, it needs to be understood that the orientation or position relations denoted by such terms as “central,” “longitudinal,” “latitudinal,” “length,” “width,” “thickness,” “above,” “below,” “front,” “rear,” “left,” “right,” “vertical,” “horizontal,” “top,” “bottom,” “inside,” “outside,” “clockwise,” “counterclockwise,” or the like are based on the orientation or position relations as shown in the accompanying drawings, and are used only for the purpose of facilitating description of this disclosure and simplification of the description, instead of indicating or suggesting that the denoted devices or elements must be oriented specifically, or configured or operated in a specific orientation. Thus, such terms should not be construed to limit this disclosure. In addition, such terms as “first” and “second” are only used for the purpose of description, rather than indicating or suggesting relative importance or implicitly indicating the number of the denoted technical features. Accordingly, features defined with “first” and “second” can, expressly or implicitly, include one or more of the features. In the description of this disclosure, “plurality” means two or more, unless otherwise defined explicitly and specifically.

Herein, unless otherwise specified and defined explicitly, if a first feature is “on” or “beneath” a second feature, this can cover direct contact between the first and second features, or contact via another feature therebetween, other than the direct contact. Furthermore, if a first feature is “on,” “above,” or “over” a second feature, this can cover the case that the first feature is right above or obliquely above the second feature, or just represent that the level of the first feature is higher than that of the second feature. If a first feature is “beneath,” “below,” or “under” a second feature, this can cover the case that the first feature is right below or obliquely below the second feature, or just represent that the level of the first feature is lower than that of the second feature.

The disclosure below provides many different embodiments or examples to realize different structures described herein. To simplify the disclosure herein, the following give the description of the parts and arrangements embodied in specific examples. They are only examples, not intended to limit this disclosure. Besides, this disclosure can repeat a reference number and/or reference letter in different examples, and such repeat is for the purpose of simplification and clarity, which does not represent any relation among various embodiments and/or arrangements as discussed. In addition, this disclosure provides examples of various specific processes and materials, but those skilled in the art can also be aware of application of other processes and/or use of other materials.

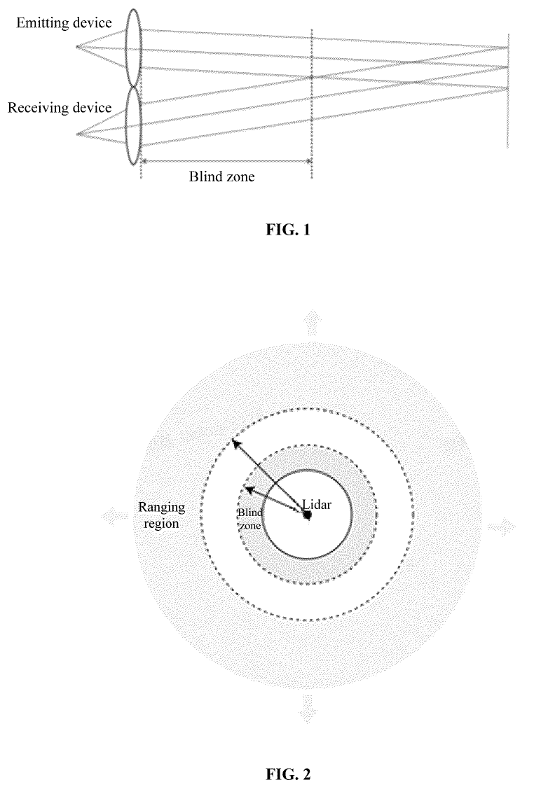

The horizontal FOVs of LiDARs can include a 360-degree FOV or a non-360-degree FOV. Based on the principle of a short-range blind zone formed by a LiDAR, similar to FIG. 1, an example relationship between a blind zone and a ranging region of a LiDAR with a 360-degree FOV is shown in FIG. 2 and an example relationship between a blind zone and a ranging region of a LiDAR with a non-360-degree FOV is shown in FIG. 3. The blind zone can correspond to a short-range region. An echo generated by an object in the blind zone can be weak and the echo can be difficult to be identified. Even if the echo can be identified, the deviation can be large when obtaining the object information based on the echo, which can cause a low resolution of object detection in the blind zone. The LiDAR cannot generate a point cloud in the blind zone. The ranging region corresponds to a long-distance region outside the blind zone. The LiDAR can detect an object outside the blind zone and generate a point cloud outside the blind zone.

A region between the blind zone and the ranging region (e.g., a region between two dotted lines in the figure) can be the width of a vehicle where the LiDAR is installed (e.g., the width of the body of the vehicle or the width of the front end of the vehicle) as an example. This region can be also a non-detectable region for the LiDAR (e.g., a region in which no point cloud is generated).

Although the LiDAR cannot accurately detect an object in the blind zone, when an obstruction exists in the blind zone (e.g., dirt on the surface of the cover), the laser emission light path can be affected. The LiDAR's detection of a long-distance object outside the blind zone can be affected.

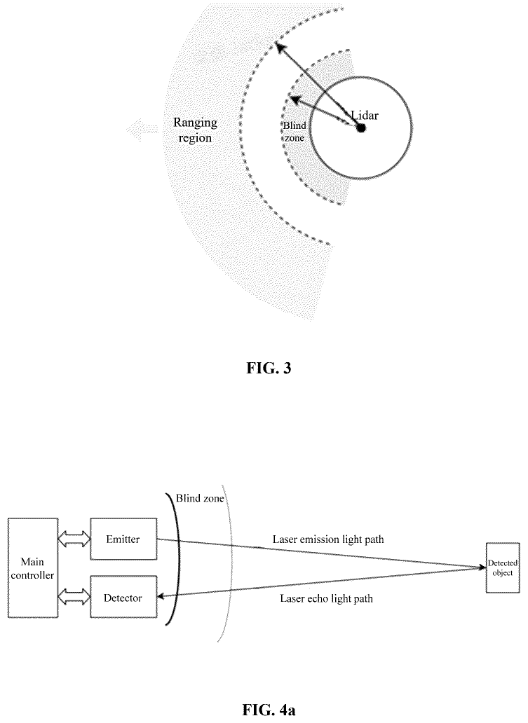

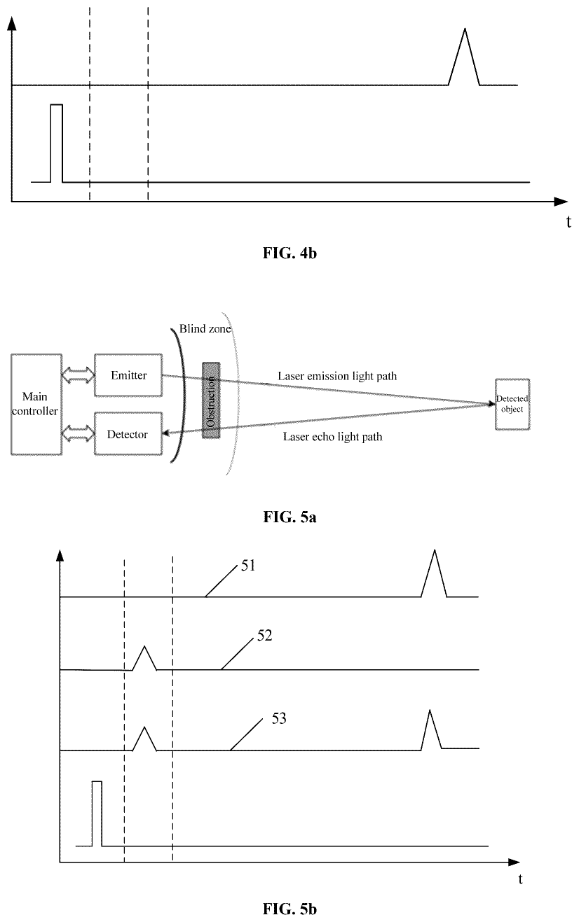

FIG. 4a shows a schematic diagram of an example detection light path of a LiDAR when no obstruction exists. FIG. 5a shows a schematic diagram of an example detection light path of a LiDAR when an obstruction exists. FIG. 4b shows a schematic diagram of an example echo corresponding to FIG. 4a when no obstruction exists. FIG. 5b shows a schematic diagram of an example echo corresponding to FIG. 5a when an obstruction exists.

For example, referring to FIG. 4a, when no obstruction exists in the blind zone of the LiDAR (e.g., no obstruction exists in the blind zone and no dirt or attachment exists on the surface of the cover), each time an emitter is triggered to emit detection light, a detector can receive an echo only from a detection object outside the blind zone (e.g., as shown in FIG. 4b.)

A square wave signal in FIG. 4b is an example detection light signal emitted by the emitter, and a time period represented by dotted lines is an example obstruction time window corresponding to the blind zone.

For example, referring to FIG. 5a, when an obstruction exists in the blind zone of the LiDAR, each time an emitter is triggered to emit detection light, the obstruction can have various effects on the detection light, such as transmission, refraction, scattering, absorption, reflection or other situations. Different situations can have different effects on the detection light and echo. Correspondingly, an echo received by a detector can occur in various situations. For example, referring to FIG. 5b, an example echo without obstruction in the blind zone (i.e., an echo only come from the obstruction in the blind zone, shown in 51 in FIG. 5b) is shown to compare various situations with a situation where no obstruction exists in the blind zone. In another situation where an obstruction exists, there is an echo only from the obstruction in the blind zone, as represented by 52 in FIG. 5b. No echo from the detection object can represent that the detection light emitted by the emitter is completely or mostly reflected. In yet another situation where an obstruction exists, there can be both an echo from the obstruction in the blind zone and an echo from the detection object, as represented by 53 in FIG. 5b, which represents that an obstruction exists, but the occlusion is not strong and the echo from detection object can still be received.

Similarly, a square wave signal in FIG. 5b is an example detection light signal emitted by the emitter, and a time period represented by dotted lines is an example obstruction time window corresponding to the blind zone.

It should be noted that when no obstruction exists in the blind zone or the degree of occlusion of the obstruction is weak, the echo received by the detector within a time window corresponding to the blind zone can be weak and can not be identified. The obstruction in this disclosure refers to an obstruction that has affected the emission of detection light and/or the reception of an echo due to its existence, so that the obstruction in the blind zone can scatter or reflect most or all of the detection light, making the echo generated by the obstruction strong and identifiable.

Based on the above characteristics, some embodiments of this disclosure provide an obstruction detection method for a LiDAR. By obtaining the echo generated by the detection light emitted by the LiDAR within the obstruction time window corresponding to the blind zone, it is determined whether an obstruction exists based on the characteristic parameter of the echo generated by the detection light within the obstruction time window.

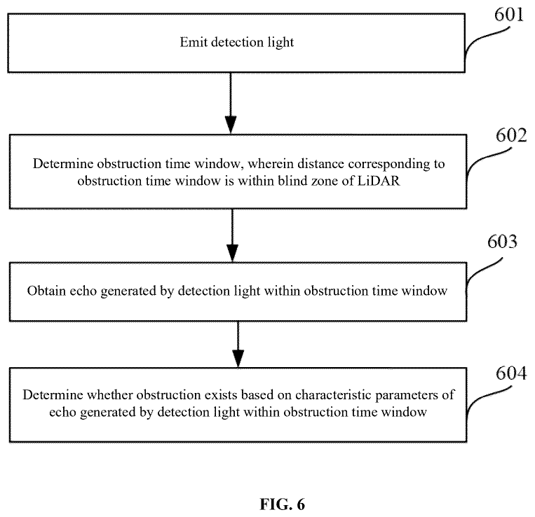

FIG. 6 shows a flow chart of an example obstruction detection method for a LiDAR, consistent with some embodiments of this disclosure. For example, referring to FIG. 6, an example obstruction detection method for a LiDAR is provided. The method includes the following steps:

At step 601, a detection light can be emitted.

The LiDAR can include a light emitter capable of emitting detection light. The detection light can be a single beam or multiple beams of detection light. The single beam of detection light can refer to detection light emitted by a single light emitter. The multiple beams of detection light can be multiple beams of detection light emitted by a single light emitter through scanning or other methods, or can be multiple beams of detection light emitted by one or more groups of light emitters directly, or can be multiple beams of detection light emitted by one or more groups of light emitters through scanning or other methods. This disclosure is not limited thereto.

At step 602, an obstruction time window can be determined, so that a distance corresponding to the obstruction time window can be within the blind zone of the LiDAR.

At step 603, an echo generated by the detection light within the obstruction time window can be obtained.

For example, with reference to FIG. 5a and FIG. 5b, when an obstruction exists in the blind zone, an echo can be generated within the obstruction time window correspondingly.

Taking advantage of this feature, in the solutions of some embodiments of this disclosure, the echo generated by the detection light within the obstruction time window after emitting the detection light can be obtained.

At step 604, whether an obstruction exists can be determined based on the characteristic parameter of the echo generated by the detection light within the obstruction time window.

The so-called obstruction in some embodiments of this disclosure can include dirt located on the surface of the cover, short-range objects other than the object which block the emission light path and generate echoes within the obstruction time window, or the like. For example, the obstruction can be a moving insect. The obstruction can also be some objects in association with the weather or environment around the LiDAR, such as rain, snow, fog, frost, ice, haze, sandstorm, or the like. The above-mentioned obstructions can produce echoes within the obstruction time window.

Corresponding to the different occlusion situations mentioned above, the characteristic parameter of the echo generated by the detection light within the obstruction time window can be different. In the solutions of some embodiments of this disclosure, the characteristic parameter of the echo generated by the detection light within the obstruction time window can be counted. Whether an obstruction exists can be determined based on the counted result. Some example determination methods are explained in detail later.

In some embodiments of this disclosure, the characteristic parameter of the echo can include one characteristic parameter of the echo.

In some embodiments of this disclosure, the characteristic parameter of the echo can include multiple characteristic parameter of the echo. When detecting an obstruction, detection can be performed based on the counted information of one or more of the characteristic parameters.

For example, corresponding identification thresholds can be determined for different characteristic parameters. Correspondingly, in the step 604, it can be determined whether an obstruction exists based on the counted value of the characteristic parameter and the identification threshold. When the characteristic parameter of the echo generated by the detection light within the obstruction time window is greater than the determined identification threshold, it is determined that the obstruction exists. This is explained in detail below.

The characteristic parameter of the echo that can be counted can include but is not limited to at least one of: a pulse width, a peak value, or an integral value. For example, the peak value of the echo generated by the detection light within the obstruction time window can be counted. When the peak value is greater than the determined peak threshold, an obstruction exists can be determined. For another example, the peak value and pulse width of the echo generated by the detection light within the obstruction time window can be counted. When the peak value is greater than the determined peak threshold, and the pulse width of the echo is greater than the determined pulse width threshold, an obstruction exists can be determined. The detection light can be a single beam of detection light emitted by one of the light emitters of the LiDAR. When an obstruction exists in the blind zone, a single echo is accordingly generated within the obstruction time window, and the characteristic parameter of the echo can be counted and compared with the identification threshold to determine whether an obstruction exists.

Furthermore, for some scenarios such as snowy weather, after a light emitter in the LiDAR emits a beam of detection light, multiple echoes can be generated within the obstruction time window. In some embodiments of the method of this disclosure, the number of echoes generated by a beam of detection light emitted by a light emitter within the obstruction time window can be counted to identify the obstruction due to a weather-related reason. For example, when the number of echoes generated by the beam of detection light within the obstruction time window is greater than a determined quantity threshold, it can be determined that the obstruction is caused by the weather. For example, the obstruction can be snow, fog, or the like.

To improve or ensure the accuracy of the detection result, the statistics of echoes generated outside the obstruction time window can also be used to make a comprehensive determination based on the counted result. For example, if the detection light does not generate an echo within the obstruction time window and generates an echo outside the obstruction time window, this situation shows that an echo from the object can be detected normally because the echo outside the obstruction time window is an echo generated by the object outside the blind zone, no obstruction exists can be determined.

In the case where the detection light includes multiple beams of detection light emitted by multiple light emitters in the LiDAR separately, the counted characteristic parameter of the echo can be the number of echoes, and the number of echoes refers to the number of echoes that can be generated by the multiple beams of detection light within the obstruction time window. The echo can be identifiable based on the characteristic parameter of the echo (e.g., one or more of a pulse width, a peak value, an integral value, or the like). For example, the characteristic parameter of the echo is greater than or equal to the corresponding identification threshold. In some embodiments, the number of echoes that can be generated by the multiple beams of detection light within the obstruction time window (e.g., the number of echoes) can be counted. When the number of echoes is greater than a determined quantity threshold, an obstruction exists can be determined. For example, it can be determined that an obstruction exists within the FOV corresponding to the multiple beams of detection light.

To determine whether an obstruction exists more accurately and at a finer granularity, in some embodiments of this disclosure, the FOV of the LiDAR can be divided into multiple regions, and the number of echoes can be counted region by region, and then whether there an obstruction in each region can be determined, which is described in detail below in conjunction with FIG. 7.

FIG. 7 shows another flow chart of an example obstruction detection method for a LiDAR, consistent with some embodiments of this disclosure. For example, referring to FIG. 7, the example obstruction detection method includes the following steps.

At step 701, the FOV of the LiDAR into multiple regions in advance can be detected.

The FOV herein can refer to a FOV that the LiDAR can detect. The FOV can be measured in angles from both vertical and horizontal dimensions.

For example, a vertical FOV of the LiDAR can be above 25° and be fan-shaped.

For example, a horizontal FOV of a mechanical rotating LiDAR can reach a 360° range, with reference to FIG. 2. The mechanical rotating LiDAR can be arranged on the roof of a vehicle. An emitter unit and a receiver unit can be installed on a rotor (e.g., a rotor equipped with one or more optical components). The rotor can rotate around the vertical axis. By doing so, detection of 360° in a horizontal direction can be achieved. For example, with reference to FIG. 3, a horizontal FOV of a semi-solid LiDAR (e.g., a scanning LiDAR) can reach a range of more than 120° and be fan-shaped. The semi-solid LiDAR can be arranged on the body or roof of a vehicle. A scanning device in the semi-solid LiDAR can deflect light to different azimuth angles in the horizontal and/or vertical directions by rotating to achieve the detection of the above FOV.

It should be understood that each unit in the embodiments described in this disclosure can include one or more physical components in whole or in part. As another example, a unit can include one or more hardware components and one or more software components. For example, an emitter unit can include a light emitting circuit, a vertical-cavity surface-emitting laser (“VCSEL”), an edge-emitting laser (“EEL”), a distributed feedback laser (“DFB”), fiber lasers, or the like. For example, a receiver unit can include a light receiving circuit, a photodiode, a single photon avalanche diode (“SPAD”), an avalanche photodiode (“APD”), a charged-coupled device (“CCD”), complementary metal-oxide-semiconductor (“CMOS”) sensor, or the like.

This disclosure is not limited in terms of the type of scanning device. In some embodiments, the scanning device can be a two-dimensional scanning device (e.g., a two-dimensional vibrating mirror), or two one-dimensional scanning devices (e.g., a combination of any two of a vibrating mirror, a swing mirror, a galvanometer mirror, a multi-faceted rotating mirror, or the like). Two one-dimensional scanning devices scan in the horizontal and vertical directions separately. By doing so, LiDAR's detection in the horizontal and vertical directions can be achieved. In addition, the scanning device can also be a one-dimensional scanning device (e.g., a multi-faceted rotating mirror), and the one-dimensional scanning device can scan in the horizontal direction or the vertical direction.

The detection light emitted by the LiDAR is projected into the entire FOV. Depending on the application scenario and scanning method of the LiDAR, the number of light emitters and triggering methods in the LiDAR vary. For example, a light emitter can be triggered at a time to emit a single beam of detection light, and the entire FOV can be covered by two-dimensional scanning. As another example, a group of light emitters can be triggered at a time to emit multiple beams of detection light, and the entire FOV can be covered by one-dimensional scanning.

The LiDAR can include multiple light emitter groups. The multiple light emitter groups can divide the FOV of the LiDAR into multiple regions in the vertical direction. The FOV of the LiDAR can be divided into multiple regions by multiple horizontal FOV angles in the horizontal direction. When an obstruction is detected, a region of the obstruction can be determined based on a light emitter, which emits detection light to detect the obstruction.

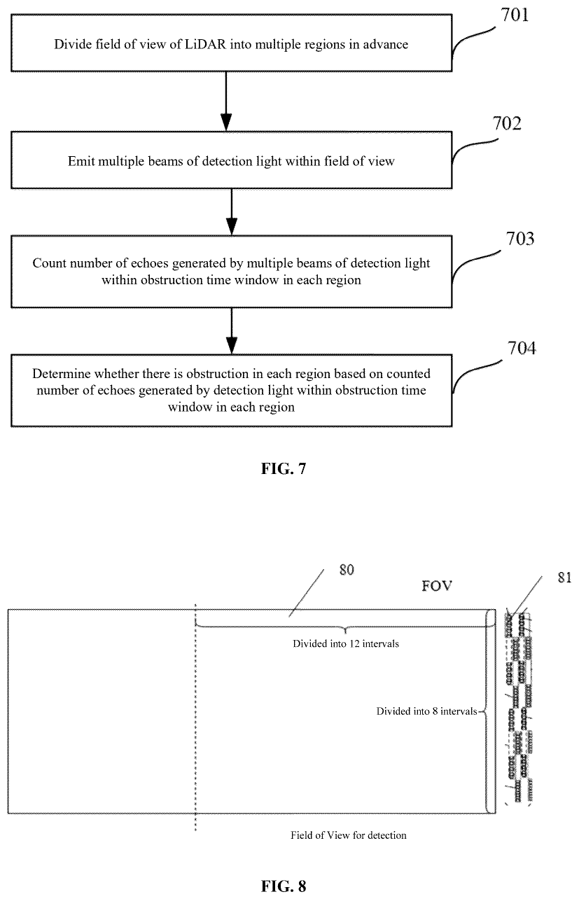

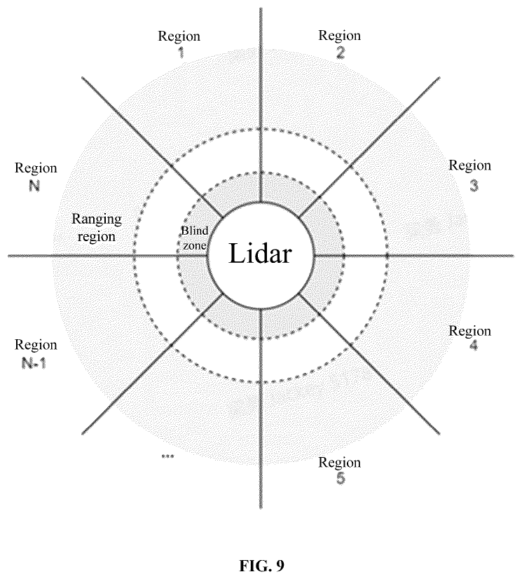

For example, referring to FIG. 8, a LiDAR includes eight light emitter groups 81.

The eight light emitter groups 81 divide a FOV 80 into eight vertical regions in the vertical direction. The horizontal FOV range is 0-120 degrees in the horizontal direction, and the FOV 80 is divided into twelve horizontal regions with the granularity of 10 degrees in the horizontal direction. An example correspondence between each channel and the twelve horizontal regions is shown in Table 1.

TABLE 1

| | | | | | | | |
|---|---|---|---|---|---|---|---|
| 0°-10° | 10.1°-20° | 20.1°-30° | 30.1°-40° | . . . | 90.1°-100° | 100.1°-110° | 110.1°-120° |

Channels 0-15
Channels 16-31
Channels 32-47
Channels 48-63
. . .
Channels 112-127

When it is determined that an obstruction exists based on the characteristic parameter of an echo generated within the obstruction time window, a light emitter that emits detection light corresponding to the echo can determined first. A vertical region can be determined based on a light emitter group where the light emitter is located. Similarly, a horizontal region can be determined based on a horizontal FOV angle corresponding to the light emitter.

For example, it is determined that obstructions exist in a region formed by a light emitter group where channels 32-47 are located and a horizontal FOV angle of 20.1-30 degrees, a region formed by a light emitter group where channels 48-63 are located and a horizontal FOV angle of 20.1-30 degrees, a region formed by a light emitter group where channels 32-47 are located and a horizontal field of view angle of 30.1-40 degrees, and a region formed by a light emitter group where channels 48-63 are located and a horizontal field of view angle of 30.1-40 degrees.

A light emitter that emits detection light can be at least one light emitter in an emitter group. For example, the obstruction detection result of at least one light emitter can be used as the obstruction detection result of the entire light-emitter group. Similarly, the obstruction detection result of at least one light emitter can also be used as the detection result of whether an obstruction exists in the FOV (e.g., a region) corresponding to the entire light-emitter group.

In addition, in some example applications, a divided region of the FOV does not need to be very small to reduce or avoid unnecessary consumption of system resources caused by small division regions.

The size of the region can be determined by the following formula:

Size_Range≥min (the size of a spot area on the cover, and the size of a FOV area on the cover); where Size_Range represents the area of the region. For example, the Size_Range represents the area of the region projected onto the cover of the LiDAR. The size of the spot area on the cover represents the area of a spot of the detection light on the cover of the LiDAR. The size of the FOV area on the cover represents the area of the corresponding FOV of the detection light on the cover of the LiDAR. In another words, the area of the region can be greater than or equal to the smaller area of the spot area of the detection light on the cover of the LiDAR and the corresponding FOV area of the detection light on the cover of the LiDAR.

It should be noted that the size of the FOV on the cover can refer to a projection of the transceiver FOV of LiDAR onto the cover. The size of the spot area on the cover and the size of the FOV area on the cover are different in different FOV regions of the entire FOV. For example, corresponding to a central FOV region, the FOV area on the cover is typically larger than the spot area on the cover, and corresponding to an edge FOV region (a large-angle FOV region), the FOV area on the cover is smaller than the spot area on the cover.

For example, for the 360-degree FOV of the LiDAR, the FOV can be divided into N regions in the horizontal direction (e.g., the divided regions shown in FIG. 9) based on the above principles. For example, if a region is divided every 10 degrees, the FOV can be divided into 36 regions.

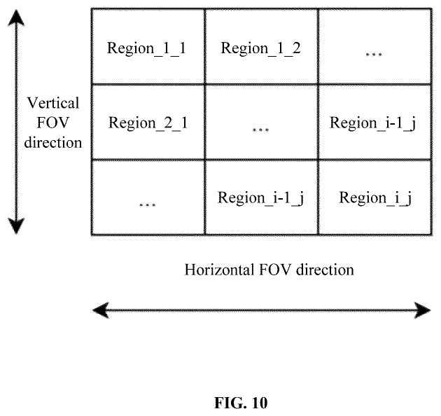

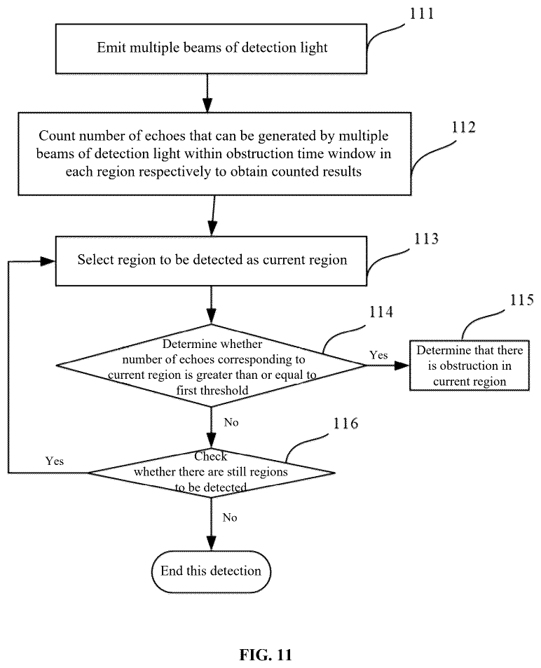

As another example, for the 120-degree FOV of the LiDAR, the FOV can be divided into multiple regions in the horizontal and vertical directions based on the above principles. For example, referring to FIG. 10, the FOV is divided into i regions in the horizontal space and j regions in the vertical space, for a total of i×j regions.

Division of each region based on the above principles can improve the accuracy of counted result and improve the accuracy of obstruction detection.

At step 702, multiple beams of detection light within the FOV can be emitted.

The multiple beams of detection light can be multiple beams of detection light that are emitted by multiple light emitters separately. For example, multiple light emitters can emit detection light in a time-sharing manner, or multiple light emitters can emit detection light in parallel.

The multiple light emitters emitting detection light in a time-sharing manner can be implemented in a variety of ways. For example, the detection light emitted by the multiple light emitters can be deflected to different azimuths in the horizontal and/or vertical direction by rotating the scanning unit to realize emission of multiple beams of detection light within the FOV. The scanning unit can be a one-dimensional or two-dimensional scanning device. As another example, multiple beams of detection light are emitted within the FOV (e.g., 360° in the horizontal direction) by rotating the detection light emitted by multiple light emitters around a rotation axis by means of a rotating mechanism.

For example, a scanning unit can include a vibrating mirror, a swing mirror, a galvanometer mirror, a rotating mirror, a rotating prism, a MEMS mirror, a combination of one or more of the above, or the like.

At step 703, the number of echoes generated by the multiple beams of detection light within the obstruction time window in each region can be counted.

There can be many ways to emit multiple beams of detection light within the FOV. Regardless of the emission method used, the number of the echoes generated by the multiple beams of detection light within the obstruction time window in each region can be counted by counting the number of echoes that can be generated by the multiple beams of detection light emitted in the region within the obstruction time window. If partial detection light in the multiple beams of detection light can generate no echo within the obstruction time window, the number of echoes generated by the partial detection light would not be counted into the number of echoes.

In addition, it should be noted that the echo is an echo that can be identified based on the characteristic parameter of the echo (e.g., one or more of a pulse width, a peak value, an integrated value, or the like). For example, the characteristic parameter of the echo can be greater than or equal to the corresponding identification threshold.

In some embodiments, the number of echoes generated by the multiple beams of detection light within the obstruction time window is counted based on each divided region, and the counted result corresponding to each region can be stored.

In some embodiments, at the above step 703, the number of echoes generated by the detection light within the obstruction time window in each region can be counted once, or the number of echoes generated by the detection light within the obstruction time window in each region can be counted multiple times.

At step 704, whether an obstruction exists in each region can be determined based on the counted number of echoes generated by the detection light within the obstruction time window in the region.

When the number of echoes is greater than the determined quantity threshold, it is determined that an obstruction exists in the region. When the number of echoes is less than or equal to the determined quantity threshold, it is determined that no obstruction exists in the region.

When determining whether an obstruction exists in each region based on the counted result, the determination can be based on the number of echoes counted in a single region, or the determination can be comprehensively made based on the counted number of echoes in the current region and its adjacent regions.

Based on the above-mentioned divided regions, several examples of determining whether an obstruction exists in each region by counting the number of echoes in each region are described below.

FIG. 11 shows a flow chart illustrating an example implementation of an obstruction detection method for a LiDAR, consistent with some embodiments of this disclosure.

For example, referring to FIG. 11, the obstruction detection method in some embodiments includes the following steps.

At step 111, multiple beams of detection light can be emitted.

At step 112, the number of echoes that can be generated by the multiple beams of detection light within the obstruction time window in each region can be counted to obtain the counted result.

In some embodiments, the number of echoes that can be generated by the multiple detection light beams emitted at one time within the obstruction time window can be counted.

The above-mentioned counting of the number of echoes that can be generated by the multiple detection light beams emitted at one time within the obstruction time window includes the number of times of counting the number of echoes corresponding to the multiple beams of detection light emitted by multiple light emitters in the region being one time, and there is no limit to the method (e.g., scanning, rotation, or the like) used by the multiple light emitters to emit the multiple beams of detection light in the region.

At step 113, a region to be detected can be selected as the current region.

At step 114, whether the number of echoes corresponding to the current region is greater than or equal to a first threshold can be determined. If the number of echoes corresponding to the current region is greater than or equal to the first threshold, step 115 can be executed. If the number of echoes corresponding to the current region is smaller than the first threshold, step 116 can be executed.

At step 115, an obstruction exists in the current region can be determined.

At step 116, whether there is still a region to be detected can be checked. If there is still a region to be detected, step 113 can be performed. If there can be no region to be detected, this detection can be ended.

In this embodiment, whether an obstruction exists in the region can be determined based on the number of echoes in each region counted once.

In some embodiments, not only the counted number of echoes in the current region is considered, but also the counted number of echoes in an adjacent region can be considered to make a comprehensive determination. By doing so, the accuracy of the detection result can be further improved.

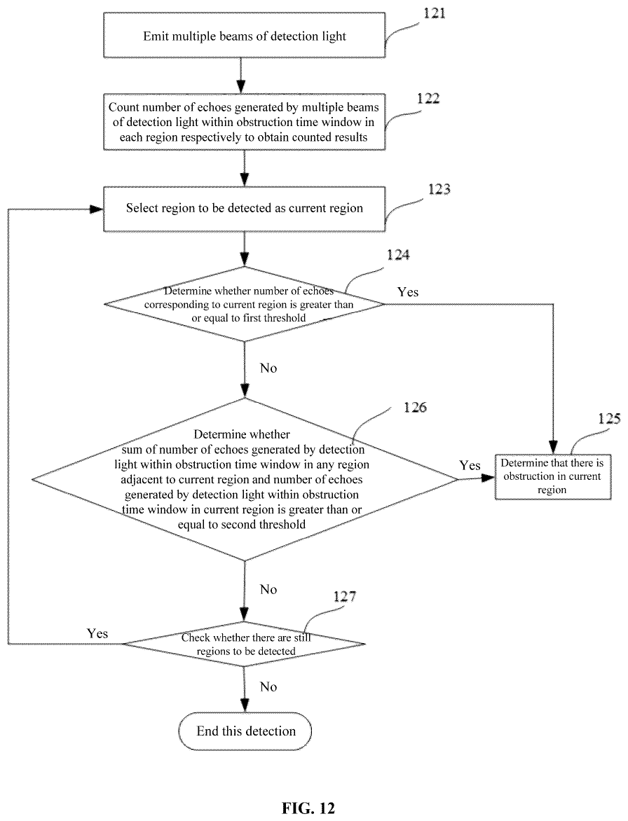

FIG. 12 shows a flow chart illustrating another example implementation of an obstruction detection method for a LiDAR, consistent with some embodiments of this disclosure. For example, referring to FIG. 12, the obstruction detection method in some embodiments includes the following steps.

At step 121, multiple beams of detection light are emitted.

At step 122, the number of echoes generated by the multiple beams of detection light within the obstruction time window in each region is counted to obtain the counted result.

In some embodiments, the number of echoes generated by multiple beams of detection light emitted at one time within the obstruction time window can be counted.

At step 123, a region to be detected can be selected as the current region.

At step 124, whether the number of echoes corresponding to the current region is greater than or equal to a first threshold can be determined. If the number of echoes corresponding to the current region is greater than or equal to the first threshold, step 125 can be executed. If the number of echoes corresponding to the current region is smaller than the first threshold, step 126 can be executed.

At step 125, an obstruction exists in the current region can be determined.

At step 126, whether the sum of the number of echoes generated by the multiple beams of detection light within the obstruction time window in any region adjacent to the current region and the number of echoes generated by the multiple beams of detection light within the obstruction time window in the current region is greater than or equal to a second threshold can be determined. If the sum is greater than or equal to the second threshold, step 125 can be executed. If the sum is smaller than the second threshold, step 127 can be executed.

At step 127, whether there is still a region to be detected can be checked. If there is still a region to be detected, step 123 can be performed. If there is no region to be detected, this detection can be ended.

In some embodiments, based on the number of echoes in each region counted once, whether an obstruction exists in the corresponding region can be determined. When making determination, the counted results of the echo data of each region and its adjacent region can be comprehensive considered. By doing so, the accuracy of the detection result can be improved. For example, the corresponding FOV of the multiple beams of detection light on the cover of the LiDAR is in the middle of two adjacent regions. In this case, the number of echoes counted in a single region can be less than the number of echoes when the FOV is in a single region. With some embodiments shown in FIG. 12, it is also possible to accurately determine whether an obstruction exists in each region under the above circumstances.

Furthermore, in some embodiments of this disclosure, multiple counted results can also make a more accurate determination on whether an obstruction exists in each region.

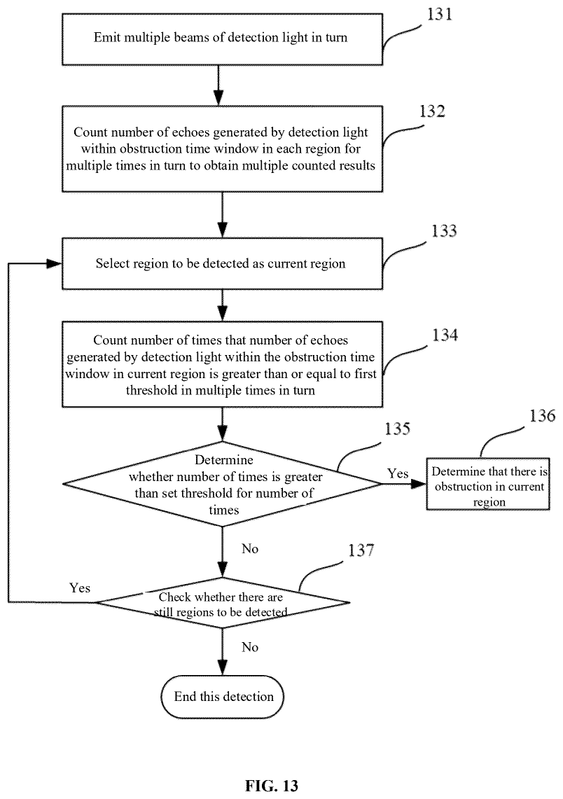

FIG. 13 shows a flow chart illustrating yet another example implementation of an obstruction detection method for a LiDAR, consistent with some embodiments of this disclosure. For example, referring to FIG. 13, the obstruction detection method includes the following steps.

At step 131, multiple beams of detection light are emitted in turn.

The multiple beams of detection light can be multiple beams of detection light that are emitted by multiple light emitters separately. For example, the multiple light emitters can emit detection light in a time-sharing manner, or the multiple light emitters can emit detection light in parallel.

The multiple light emitters emitting detection light in a time-sharing manner can be implemented in a variety of ways. For example, the detection light emitted by the multiple light emitters can be deflected to different azimuths in the horizontal and/or vertical direction by rotating the scanning unit to realize emission of multiple beams of detection light within the FOV. The scanning unit can be a one-dimensional or two-dimensional scanning device. As another example, multiple beams of detection light can be emitted within the FOV (e.g., 360° in the horizontal direction) by rotating the detection light emitted by multiple light emitters around a rotation axis by means of a rotating mechanism.

In some embodiments, multiple beams of detection light are emitted by multiple light emitters in turn. For example, multiple light emitters can periodically emit multiple beams of detection light to the corresponding FOV. For example, through scanning, multiple beams of detection light can be emitted in a time-sharing manner to cover the entire FOV in one period. Then, the scanning of the next period starts, and multiple beams of detection light can be emitted in a time-sharing manner to cover the entire FOV, and so on. As another example, a rotating mechanism can be used to realize emission in a FOV of 360°. One complete rotation of the rotating mechanism corresponds to one emission, two consecutive complete rotations is two emissions, and so on.

At step 132, the number of echoes generated by the detection light within the obstruction time window in each region for multiple times in turn is counted to obtain multiple counted results.

Corresponding to the emission of multiple detection light beams in turn as described in step 131, counting the number of echoes includes that the numbers of echoes generated by multiple beams of detection light emitted in each region for several consecutive periods within the obstruction time window are counted separately for each region. For example, if the number of echoes is counted for two times in turn, it can be counted once when the multiple beams of detection light are emitted in the region for the first time, and again when the multiple beams of detection light are emitted in the region for the second time, resulting in two counted results.

At step 133, a region to be detected can be selected as the current region.

At step 134, the number of times that the number of echoes generated by the detection light within the obstruction time window in the current region is greater than or equal to the first threshold can be counted in the multiple times in turn.

At step 135, whether the number of times is greater than the determined threshold for the number of times can be determined. if the number of times is greater than the determined threshold, step 136 can be executed. If the number of times is smaller than or equal to than the determined threshold, step 137 can be executed.

At step 136, an obstruction exists in the current region can be determined.

At step 137, whether there is still a region to be detected can be checked. If there is still a region to be detected, step 133 can be performed. If there is no region to be detected, this detection can be ended.

In some embodiments, whether an obstruction exists in the region can be determined based on the counted number of times that the number of echoes in the same region is greater than or equal to the first threshold for multiple times. By doing so, the accuracy of the detection result can be improved. For example, the corresponding FOV of the detection light on the cover of the LiDAR is in the middle of two adjacent regions. In this case, there is uncertainty in the number of echoes counted only once. For example, the number of echoes in a region 1 counted for the first time is 0, and the number of echoes in an adjacent region 2 for the first time is 1; the number of echoes in the region 1 counted for the second time is 1, and the number of echoes in the adjacent region 2 is 0. This can also affect the detection result. If only one counted result is used to determine whether an obstruction exists in each region, the accuracy of the result in some scenarios is affected. With some embodiments shown in FIG. 13, the accuracy of the detection result can be improved by determining based on multiple counted results, making the detection scheme of this disclosure more robust and better applicable to obstruction detection in various different application environments of LiDAR.

Furthermore, in some embodiments of this disclosure, the distribution of an obstruction can also be determined based on whether an obstruction exists in each region.

For example, the status mark of the region can be determined based on whether an obstruction exists in the region. A distribution region of the obstruction can be determined based on the status mark of each region, and/or a degree of occlusion of the obstruction can be determined based on the status mark of each region.

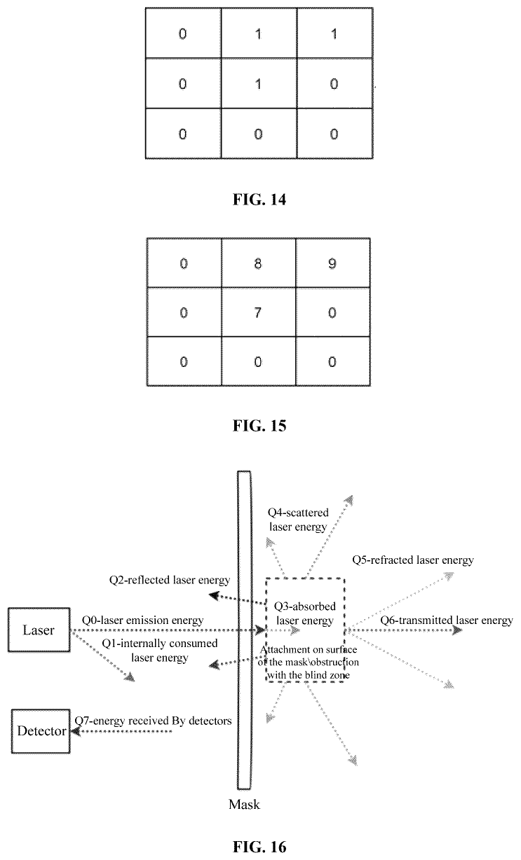

For example, in some embodiments, for each region, after it is determined that an obstruction exists in the region, the status mark of the region is marked as 1, and the status mark of a region without an obstruction is marked as 0. For example, 1 represents that an obstruction exists in the region, and 0 represents that there is no obstruction in the blind zone. For example, referring to FIG. 14, it is assumed that the FOV of the LiDAR is divided into 9 regions. Each region corresponds to a FOV of a light emitter. After the light emitter emits detection light, an echo is generated within the obstruction time window. It is considered that an obstruction exists in this region, and the region is marked as 1, otherwise it is marked as 0. In this way, the distribution of the obstruction within the entire FOV of the LiDAR can be presented based on the status mark of each region. It should be noted that the echo is an echo that can be identified based on the characteristic parameter of the echo (e.g., one or more of a pulse width, a peak value, an integral value), the characteristic parameter of the echo is greater than or equal to the corresponding identification threshold.

As another example, in some embodiments, the number of echoes generated by the detection light within the obstruction time window in the region is counted, and the region is marked with the number of echoes, for example, referring to FIG. 15. It is also assumed that the FOV of the LiDAR is divided into 9 regions. For example, each region corresponds to a FOV of a light emitter. The number of echoes generated within the obstruction time window after the light emitter emits detection light is used as the status mark of this region, and a region without an echo is marked as 0. For example, number 7 in FIG. 15 is the counted number of echoes in a first corresponding region. number 8 in FIG. 15 is the counted number of echoes in a second corresponding region. number 9 in FIG. 15 is the counted number of echoes in a third corresponding region. In this way, some scenarios can be identified based on the status mark of each region, such as an obstruction caused by snow and other weather conditions. After a light emitter emits a single beam of detection light, multiple echoes are generated within the obstruction time window, the number of all echoes is counted, and the status of the corresponding region is marked based on the counted result. As another example, each region corresponds to the FOV of multiple light emitters. After the multiple light emitters emit multiple beams of detection light, the number of echoes that can be generated by the multiple beams of detection light within the obstruction time window is used as the status mark of the region, and a region without an echo is marked as 0. For example, number 7 in FIG. 15 is the counted number of echoes in a first corresponding region. number 8 in FIG. 15 is the counted number of echoes in a second corresponding region. number 9 in FIG. 15 is the counted number of echoes in a third corresponding region. The corresponding regions are marked with the status marks based on the counted results.

It should be noted that the various thresholds mentioned above can be determined based on test and calibration. For example, calibration can be made by the characteristic parameter of the echo (e.g., one or more of a pulse width, a peak value, an integrated value, and the number of echoes), and the point cloud performance under different conditions of attachment and dirt on the cover surface and in different occlusions and the characteristic parameter of the echo generated within the obstruction time window can be tested, to determine whether the characteristic parameter of the echo (e.g., one or more of a pulse width, a peak value, an integral value, and the number of echoes) has attenuated to the unrecognizable degree. Once attenuated to an unrecognizable degree, the corresponding characteristic parameter of the echo is counted, and the corresponding threshold is calibrated based on the characteristic parameter of the echo.

Considering that the application scenarios of LiDARs can be diverse, and in different scenarios, the characteristic parameter of the echo (e.g., one or more of a pulse width, a peak value, an integral value and the number of echoes) can vary due to environmental factors, such as weather, surrounding environment and other factors. To this end, various different scenarios can be included in a scenario library, and various different scenarios in the scenario library can be tested and calibrated offline to obtain threshold data corresponding to different scenarios and the characteristic parameter of the echo that needs to be counted. In some applications, the threshold data and the characteristic parameter of the echo can be selected to be adapted to the current environment.

Furthermore, considering that the environment can change in a dynamic manner, in the application of some example schemes of this disclosure, the current environment can also be identified in a dynamic manner, such as through a camera, or other sensors. The threshold data and the characteristic parameter of the echo that are adapted to the current environment can be changed in a dynamic manner based on the changes in the current environment.

Due to different types of obstructions, the degrees of occlusion are also different, and the impacts on the detection result of the LiDAR can also be different.

For example, referring to FIG. 16, the obstruction can be a A-type obstruction or a B-type obstruction. Among them, detection light can pass through the A-type obstruction and cannot pass through the B-type obstruction. For example, the A-type obstruction can include a transmissive obstruction, a refractive obstruction, or a scattering obstruction, and the B-type obstruction can include an absorptive obstruction, or a reflective obstruction.

The B-type obstruction can, for example, include asphalt, paint, dust, soil, or the like, and the A-type obstruction can, for example, include a scratch, a stone pit, an insect corpse, a bird dropping, oil sweat, a fingerprint, sewage, clean water, or the like.

For example, still referring to FIG. 16, Q0 represents the laser emission energy, Q1 represents the internally consumed laser energy, Q2 represents the laser energy reflected by the reflective obstruction, Q3 represents the laser energy absorbed by the absorptive obstruction, Q4 represents the laser energy scattered by the scattering obstruction, Q5 represents the laser energy refracted by the refractive obstruction, Q6 represents the laser energy transmitted by the transmissive obstruction, and Q7 represents the laser energy received by the optical receiver.

Accordingly, the degree of occlusion of the obstruction can be determined based on the type of obstruction.

In some embodiments of this disclosure, the number of echoes outside the obstruction time window can also be counted, and the type of the obstruction is determined based on the counted result.

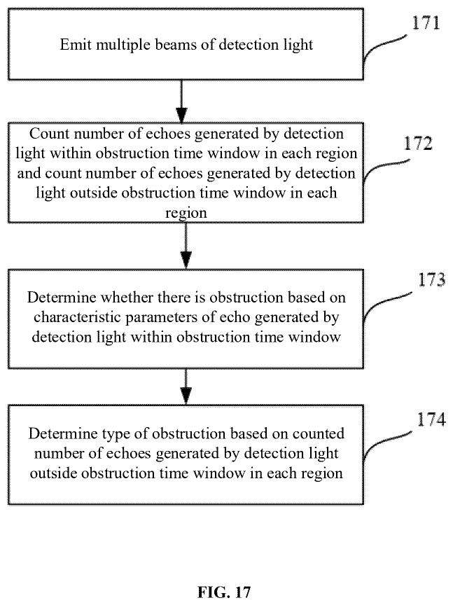

For example, referring to FIG. 17, a flow chart of another example implementation of an obstruction detection method for a LiDAR consistent with some embodiments of this disclosure is illustrated. The obstruction detection method of some embodiments can not only determine whether an obstruction exists, but also determine the type of obstruction. Some embodiments shown in FIG. 17 include the following steps:

At step 171, multiple beams of detection light can be emitted.

At step 172, the number of echoes generated by the detection light within the obstruction time window in each region can be counted, and the number of echoes generated by the detection light outside the obstruction time window in each region can be counted.

At step 173, whether an obstruction exists based on the characteristic parameter of the echo generated by the detection light within the obstruction time window can be determined. If an obstruction exists, step 174 can be executed further.

Reference can be made to the descriptions in the previous embodiments for the example methods of determining whether an obstruction exists based on the characteristic parameter of the echo generated by the detection light within the obstruction time window.

At step 174, the type of obstruction based on the counted number of echoes generated by the detection light outside the obstruction time window in each region is determined.

For example, if the number of echoes that can be generated by the multiple beams of detection light outside the obstruction time window in the region is less than a third threshold, the obstruction is determined to be a first type of obstruction; otherwise, the obstruction is determined to be a second type of obstruction, wherein the degree of occlusion of the first type of obstruction is greater than the degree of occlusion of the second type of obstruction.

In some embodiments of this disclosure, the obstructions are divided into two types based on their degrees of occlusion, namely the first type of obstruction and the second type of obstruction mentioned above. Among them, the first type of obstruction can be a B-type obstruction. In the presence of an obstruction (including an attachment on the surface of the cover or an obstruction in the blind zone) as the B-type obstruction, the ranging performance of the LiDAR is attenuated and the number of echoes outside the obstruction time window is small. The second type of obstruction can be a A-type obstruction. In the presence of an obstruction (including an attachment on the surface of the cover or an obstruction in the blind zone) as the A-type obstruction, the ranging performance of the LiDAR is attenuated but the number of echoes outside the obstruction time window is within the allowed range. For example types of obstructions, reference can be made to the descriptions in the previous embodiments. In some applications, the types of obstructions can also be divided in other ways or granularities.

Similarly, the above-mentioned third threshold can also be determined through a calibration method. For the example calibration method, reference can be made to the previous description.

Since the scenario where the LiDAR is located is a dynamic scenario, the third threshold changes accordingly as the scenario changes. For example, the number of echoes outside the obstruction time window counted at timestamp t1 is X, and the counted number of echoes outside the obstruction time window can change even if no obstruction exists within the blind zone at timestamp t2. If the detection object corresponding to the counted region at timestamp t1 is an entire tree, and the third threshold is determined to 100, as a vehicle where the LiDAR is located moves, the detection object corresponding to the counted region at timestamp t2 becomes half a tree, and the determined third threshold should become 50.

In some embodiments of the method of this disclosure, the third threshold can also be updated in a dynamic manner based on the surrounding environment of the LiDAR. For example, the third threshold for the current obstruction detection is obtained by performing weight calculation based on the third threshold for the last obstruction detection and the historically counted number of echoes generated by the detection light outside the obstruction time window. For example, the following formula can be used:

$$SingleRangeThres\_Curr = {α}^{*} SingleRangeThres\_last + β * SingleRangeEchoNum ;$$

Where α and β are empirical values and can be determined based on the actual test process; SingleRangeThres_Curr represents the third threshold that needs to be used for the current obstruction detection, SingleRangeThres_last represents the third threshold used for the last obstruction detection, and SingleRangeEchoNum represents the counted number of echoes generated by the detection light outside the obstruction time window, which is historically obtained.

The type of obstruction can be determined more accurately through the above-mentioned dynamic changes of the third threshold, and the third threshold can be updated in real time based on a variety of parameters, so that the third threshold does not change suddenly, thereby reducing or avoiding the sudden changes in the third threshold from producing erroneous detection results.

Furthermore, in some embodiments of the method of this disclosure, fault information can also be reported based on the obstruction detection result.

For example, when only whether an obstruction exists is detected in applications, corresponding fault information can be reported when the obstruction is detected.

As another example, when not only whether an obstruction exists is detected, but also the distribution of the obstruction is determined in applications, the distribution of the obstruction can be reported.

As another example, when not only whether an obstruction exists is detected, but also the type of obstruction is detected, the corresponding obstruction type code can be reported. For example, the obstruction type for each divided region can be represented by a 2-bit code, where bit [0] represents a A-type obstruction, 1 represents that there is an A-type obstruction, 0 represents that there is no A-type obstruction, bit [1] represents a B-type obstruction, 1 represents that there is a B-type obstruction, and 0 represents that there is no B-type obstruction.

Correspondingly, the truth table corresponding to the obstruction detection results can be shown in Table 2 below.

TABLE 2

| Bit | bit[0] | bit[1] |
|---|---|---|
| bit[0] | No obstruction detected | A-type obstruction |
| bit[1] | B-type obstruction | B-type obstruction |

It can be seen that with the solutions of this disclosure, it is not only possible to detect whether an obstruction exists, but also to detect the type of obstruction, and the detection results can also be reported, so that relevant personnel can accurately determine the impact on the detection results, and then take corresponding measures to improve or ensure the detection performance of the LiDAR. In addition, since the obstruction detection process is completed based on counted data, the solution of this disclosure can be implemented through software. Therefore, there is no need to change the hardware of the existing LiDAR to detect an obstruction, and the cost can not be increased.

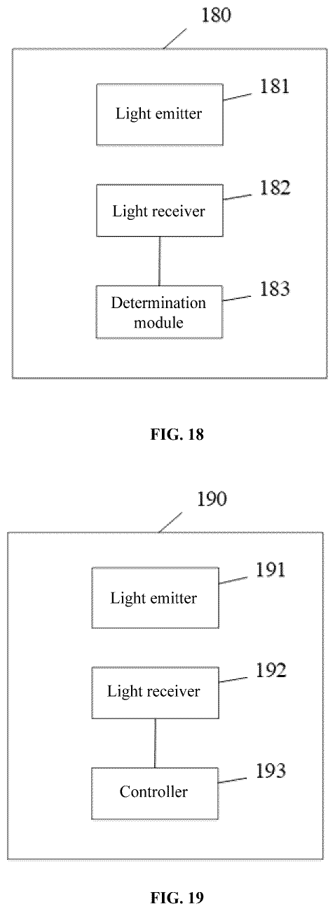

Correspondingly, some embodiments of this disclosure further provide an obstruction detection device for a LiDAR, for example, referring to FIG. 18, which shows a schematic structural diagram of an example detection device. The device 180 includes a light emitter 181, a light receiver 182, and a determination module 183. The light emitter 181 can emit detection light. The light receiver 182 can obtain an echo generated by the detection light within an obstruction time window. The obstruction time window can be determined based on a detection range in which a point cloud cannot be generated after the detection light is emitted. The determination module 183 can determine whether an obstruction exists based on the characteristic parameter of the echo generated by the detection light within the obstruction time window.

For example, a determination module can be implemented as a processor, a controller, a computer or any form of hardware components. As another example, a processor unit can include one or more hardware components and one or more software components. For example, the processor unit can include a processor (e.g., a digital signal processor, microcontroller, field programmable gate array, a central processor, an application-specific integrated circuit, or the like) and a computer program, when the computer program is run on the processor, the function of the processor module can be realized, the computer program can be stored in a memory (e.g., a random access memory, a flash memory, a read-only memory, an programmable read-only memory, a register, a hard disk, a removable hard disk, or a storage medium of any other form) or server.

The light emitter 181 can include one or more light emitter. Correspondingly, the emitted detection light can be a single beam or multiple beams. Reference can be made to the previous description in the method embodiment of this disclosure for the example emission method.

There can be many characteristic parameters of the echo, including but not limited to at least one of: a pulse width, a peak value, an integrated value, or the number of echoes, for example. When detecting an obstruction, detection can be performed based on the counted information of one or more characteristic parameters. For different characteristic parameters, corresponding identification thresholds can be determined. Correspondingly, the light receiver 182 can determine whether an obstruction exists based on the counted value of the characteristic parameter and the identification threshold. When the characteristic parameter of the echo generated by the detection light within the obstruction time window is greater than the determined identification threshold, it is determined that an obstruction exists.

Furthermore, the FOV of the LiDAR can also be divided into multiple regions. Correspondingly, the determination module 183 can count the number of echoes generated by the detection light within the obstruction time window in each region. It is determined whether an obstruction exists in each region based on the counted number of echoes generated by the detection light within the obstruction time window in each region, so that whether an obstruction exists can be determined more accurately and at a finer granularity.

It should be noted that the determination module 183 can count the number of echoes generated by the detection light within the obstruction time window once or multiple times. Reference can be made to the description in the method embodiments of this disclosure for details.

In addition, the determination module 183 can also count the number of echoes generated by the detection light outside the obstruction time window, and can further determine the type of obstruction based on the counted number of echoes generated by the detection light outside the obstruction time window in each region.

More information about the working principle and working mode of the obstruction detection device 180 for a LiDAR can be found in the relevant descriptions in the method embodiments of this disclosure.

Correspondingly, some embodiments of this disclosure also provide a LiDAR. For example, still referring to FIG. 19, the LiDAR 190 includes a light emitter 191, a light receiver 192, and a controller 193.

The light emitter 191 can emit detection light. The light receiver 192 can receive an echo generated by the detection light within an obstruction time window and/or an echo generated by the detection light outside the obstruction time window. The controller 193 can store therein a computer program, which, when run by the controller, performs the steps of the obstruction detection method for a LiDAR as described above.

In some embodiments, the controller 193 can include a chip with an obstruction detection function in a LiDAR or a terminal device, such as a system-on-a-chip (“SOC”), a baseband chip, or the like. In some embodiments, the controller 193 can include a component including a chip with an obstruction detection function in a LiDAR or a terminal device. In some embodiments, the controller 193 can include a chip module with a data processing function chip. In some embodiments, the controller 193 can be associated with a LiDAR or a terminal device.

Some embodiment of this disclosure further discloses a storage medium. The storage medium is a computer-readable storage medium, and a computer program is stored thereon. When the computer program is run, the steps of the foregoing method can be executed. The storage medium can include a ROM, RAM, magnetic disk or optical disk, or the like. The storage medium can also include a non-volatile memory or non-transitory memory, or the like.

The terms “or” and “and/or” of this disclosure describe an association relationship between associated objects, and represent a non-exclusive inclusion. For example, each of “A and/or B” and “A or B” can include: only “A” exists, only “B” exists, and “A” and “B” both exist, where “A” and “B” can be singular or plural. For another example, each of “A, B, and/or C” and “A, B, or C” can include: only “A” exists, only “B” exists, only “C” exists, “A” and “B” both exist, “A” and “C” both exist, “B” and “C” both exist, and “A”, “B”, and “C” all exist, where “A,” “B,” and “C” can be singular or plural. In addition, the symbol “/” herein represents that the associated objects before and after the character are in an “or” relationship. In this disclosure, the term “at least one of A or B” has a meaning equivalent to “A or B” as described above. The term “at least one of A, B, or C” has a meaning equivalent to “A, B, or C” as described above.

The term “multiple” in this disclosure refers to a number of two or more.

The “first”, “second” or the like appearing in the embodiments of this disclosure are only for illustration and to distinguish the described objects but not in order, do not represent special limitations on the number of devices in the embodiments of this disclosure, and should form any limitations of the embodiments of this disclosure.

The “connection” appearing in the embodiments of present disclosure refers to various connection methods such as direct connection or indirect connection to realize communication between devices, and the embodiments of present disclosure do not limit this in any way.

1-20. (canceled)

21. A method of obstruction detection for a LiDAR, performed by a controller of the LiDAR, comprising:
determining an obstruction time window based on a blind zone of the LiDAR, wherein the obstruction time window corresponds to a distance within the blind zone;
obtaining an echo signal corresponding to one or more echoes of a detection light within the obstruction time window, wherein the one or more echoes are received by a light receiver of the LiDAR, and the detection light is emitted by a light emitter of the LiDAR;
determining a number of the one or more echoes; and
generating an obstruction signal based on the number of the one or more echoes and a predetermined threshold.

22. The method of claim 21, wherein generating the obstruction signal based on the number of the one or more echoes and the predetermined threshold comprises:
generating the obstruction signal when the number of the one or more echoes exceeds the predetermined threshold.

23. The method of claim 21, wherein the detection light comprises a plurality of detection beams emitted by a plurality of light emitters in the LiDAR.

24. The method of claim 23, wherein:
the number of the one or more echoes comprises a first number of echoes within the obstruction time window in a first region of a field of view of the LiDAR and a second number of echoes within the obstruction time window in a second region of the field of view of the LiDAR; and
the predetermined threshold comprises a first predetermined threshold and a second predetermined threshold, and
wherein generating the obstruction signal based the number of the one or more echoes and the predetermined threshold further comprises at least one of:
generating a first obstruction signal based on the first number and the first predetermined threshold, or
generating a second obstruction signal based on the second number and the second predetermined threshold.

25. The method of claim 24, wherein generating the first obstruction signal based on the first number and the first predetermined threshold comprises generating the first obstruction signal when the first number exceeds the first predetermined threshold; or
wherein generating the second obstruction signal based on the second number and the second predetermined threshold comprises generating the second obstruction signal in response to the second number exceeds the second predetermined threshold.

26. The method of claim 25, wherein an area of the first region is greater than or equal to an area of a spot of the detection light on a cover of the LiDAR and a corresponding field of view of the detection light on the cover of the LiDAR, the area of the first region comprising a projected area of the first region onto the cover of the LiDAR.

27. The method of claim 24,
wherein generating the first obstruction signal based on the first number and the first predetermined threshold comprises:
generating the first obstruction signal when the first number is less than the first predetermined threshold and a sum of the first number and the second number is greater than or equal to a third predetermined threshold; and
wherein the second region is adjacent to the first region.

28. The method of claim 24, further comprising:
determining a distribution of the obstruction based on the first obstruction signal and the second obstruction signal.

29. The method of claim 28, wherein determining the distribution of the obstruction based on the first obstruction signal and the second obstruction signal comprises:
determining a first status mark of the first region based on the first obstruction signal;
determining a second status mark of the second region based on the second obstruction signal; and
determining at least one of a distribution region of the obstruction or a degree of the obstruction based on the first status mark and the second status mark.

30. The method of claim 23, further comprising:
determining a number of times where the number of the one or more echoes of the detection light within the obstruction time window in a first region of a field of view of the LiDAR is greater than or equal to the predetermined threshold; and
generating the obstruction signal in the first region based on the number of times and a predetermined count threshold.

31. The method of claim 30, wherein generating the obstruction signal in the first region based on the number of times and the predetermined count threshold comprises:
generating the obstruction signal in the first region when the number of times exceeds the predetermined count threshold.

32. The method of claim 24, further comprising:
determining a third number of echoes of the detection light outside the obstruction time window in the first region, and
determining a type of the obstruction based on the third number.

33. The method of claim 32,
wherein determining the type of the obstruction based on the third number comprises:
determining a first type of the obstruction in response to the third number being less than a fourth predetermined threshold; or
determining a second type of the obstruction in response to the third number being greater than or equal to the fourth predetermined threshold; and
wherein a degree of the obstruction of the first type is greater than a degree of obstruction of the second type.

34. The method of claim 33, wherein the first predetermined threshold and the fourth predetermined threshold are determined through calibration.

35. The method of claim 33, further comprising:
dynamically updating the fourth predetermined threshold based on a surrounding environment of the LiDAR.

36. The method of claim 35, wherein dynamically updating the fourth predetermined threshold based on the surrounding environment of the LiDAR comprises:
determining the fourth predetermined threshold for a present obstruction detection based on a previous fourth predetermined threshold for a previous obstruction detection and a previous third number of echoes of the detection light outside the obstruction time window for a previous obstruction detection.

37. The method of claim 21, further comprising:
generating a fault information signal based on the obstruction signal.

38. A LiDAR, comprising:
a light emitter configured to emit a detection light;
a light receiver configured to receive one or more echoes of the detection light within an obstruction time window and/or an echo of the detection light outside the obstruction time window; and
a controller configured to
determining the obstruction window based on the blind zone of the LiDAR, wherein the obstruction time window corresponds to a distance within a blind zone of the LiDAR;
obtaining an echo signal corresponding to the one or more echoes of the detection light within the obstruction time window;
determining a number of the one or more echoes; and
generating an obstruction signal based on the number of the one or more echoes and a predetermined threshold.

39. The LiDAR of claim 38, wherein generating the obstruction signal based on the number of the one or more echoes and the predetermined threshold comprises:
generating the obstruction signal when the number of the one or more echoes exceeds the predetermined threshold.
